(19) United States
(12) Patent Application Publication
(10) Pub. No.: US 2023/0033609 A1
(43) Pub. Date: Feb. 2, 2023

(54) METHOD OF MANAGING AT LEAST ONE NETWORK ELEMENT

(71) Applicant: Rakuten Mobile, Inc., Tokyo (JP)

(72) Inventors: Mamadu Bah, Tokyo (JP); Clintonchogo Kavai, Tokyo (JP); Anshul Bhatt, Tokyo (JP); Timothy Katee, Tokyo (JP)

(73) Assignee: Rakuten Mobile, Inc., Tokyo (JP)

(21) Appl. No.: 17/389,807

(22) Filed: Jul. 30, 2021

(51) Int. Cl. H04L 12/24

(52) U.S. Cl. CPC H04L 41/0879; H04L 41/0816; H04L 41/0266

(57) ABSTRACT

A method for managing at least one network element includes receiving, by a deployment platform, an instruction from a user device to execute a command on the at least one network element, the instruction comprising command metadata identifying the command within a command catalog stored in a repository; obtaining the command by the deployment platform from the repository based on the command metadata; and executing the command on the at least one network element using a framework operating on the deployment platform.

### BACKGROUND

In current network management troubleshooting frameworks, every network element type may have unique code, developed for example in Python, Shell, Go, etc. As a result, any addition or modification of commands for controlling network elements of a network element type, for example troubleshooting or audit command, requires a redeployment of code to the network element, or to a framework for controlling the network element. Accordingly, even minor updates may require an extensive amount of time and resources to deploy.

### SUMMARY

According to embodiments, a method of managing at least one network element includes receiving, by a deployment platform, an instruction from a user device to execute a command on the at least one network element, the instruction comprising command metadata identifying the command within a command catalog stored in a repository; obtaining the command by the deployment platform from the repository based on the command metadata; and executing the command on the at least one network element using a framework operating on the deployment platform.

The method may further include, based on a new command being added to the command catalog, receiving, by the deployment platform, a new instruction from the user device to execute the new command on the at least one network element, the new instruction comprising new command metadata identifying the new command within the command catalog; obtaining the new command by the deployment platform from the repository based on the new command metadata; and executing the new command on the at least one network element using the framework.

The framework may be capable of executing all commands included in the command catalog.

The framework may include a script deployed to the deployment platform by the user device.

The executing of the command may include configuring the at least one network element according to the command.

The command may be obtained by the deployment platform through an application program interface associated with the repository.

The command catalog may include information indicating whether the command is executable on the at least one network element.

According to embodiments, a deployment platform for managing at least one network element includes a memory configured to store instructions; and one or more processors configured to execute the instructions to: receive an instruction from a user device to execute a command on the at least one network element, the instruction comprising command metadata identifying the command within a command catalog stored in a repository; obtain the command from the repository based on the command metadata; and execute the command on the at least one network element using a framework operating on the deployment platform.

The one or more processors may be further configured to execute the instructions to: based on a new command being added to the command catalog, receive a new instruction from the user device to execute the new command on the at least one network element, the new instruction comprising new command metadata identifying the new command within the command catalog; obtain the new command by the deployment platform from the repository based on the new command metadata; and execute the new command on the at least one network element using the framework.

The framework may be capable of executing all commands included in the command catalog.

The framework may include a script deployed to the deployment platform by the user device.

The executing of the command may include configuring the at least one network element according to the command.

The command may be obtained by the deployment platform through an application program interface associated with the repository.

The command catalog may include information indicating whether the command is executable on the at least one network element.

According to embodiments, a non-transitory computer-readable medium may store instructions, including one or more instructions that, when executed by one or more processors of a deployment platform for managing at least one network element, cause the one or more processors to: receive an instruction from a user device to execute a command on the at least one network element, the instruction comprising command metadata identifying the command within a command catalog stored in a repository; obtain the command from the repository based on the command metadata; and execute the command on the at least one network element using a framework operating on the deployment platform.

The one or more instructions may further cause the one or more processors to: based on a new command being added to the command catalog, receive a new instruction from the user device to execute the new command on the at least one network element, the new instruction comprising new command metadata identifying the new command within the command catalog; obtain the new command by the deployment platform from the repository based on the new command metadata; and execute the new command on the at least one network element using the framework.

The framework may be capable of executing all commands included in the command catalog.

The executing of the command may include configuring the at least one network element according to the command.

The command may be obtained by the deployment platform through an application program interface associated with the repository.

The command catalog may include information indicating whether the command is executable on the at least one network element.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 is a diagram of a network management system, according to embodiments;

FIG. 2 is a diagram of an example environment in which systems and/or methods, described herein, may be implemented, according to embodiments;

FIG. 3 is a diagram of example components of one or more devices of FIG. 2, according to embodiments; and

FIGS. 4A-4B are flow charts of example processes for managing at least one network element, according to embodiments;

FIG. 5 is a diagram of an example of a command catalog, according to embodiments;

FIGS. 6A-6C are diagrams of an example user interface of a network management system, according to embodiments;

FIGS. 7A-7B are flow charts of example processes for managing at least one network element, according to embodiments.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise.

There have been many discussions recently relating to configuration-as-code. Configuration-as-code may relate to managing configuration resources in a source repository. Under a configuration-as-code concept, application configuration resources are treated as versioned artifacts. In contrast, troubleshooting is a form of problem solving, often applied to repair failed products or processes on a system. It is a logical, systematic search for the source of a problem in order to solve it and make the product or process operational again. Accordingly, configuration-as-code may cause unnecessary difficulties in a troubleshooting process.

Embodiments of the present disclosure may relate to a different concept, which may be referred as a code-as-configuration concept. Embodiments may be used to form a new bridge between the concepts of troubleshooting and configuration-as-code.

For example, embodiments may abstract the coding and scripting process into a configuration-like concept, for example managed through a repository such as Git and continuous integration and continuous development/deployment (CICD) such as Jenkins CICD.

By making use of a code-as-configuration concept, new troubleshooting steps or audit flows may be created without writing and deploying any application. In embodiments, this may be possible by updating a network element catalog in a repository such as Git with commands and regular expressions to capture output data. Once the commands are pushed to the repository, the rest may be handled by the framework. In embodiments, each command may correspond to two regular expressions, one to capture the desired output and the other to run a compliance check against the output. In embodiments, both of the regular expressions may use the Python regular expressions library to achieve the desired goals.

Code-as-configuration may become a managed resource that may be migrated across multiple environments, greatly simplifying the deployment process. Code-as-configuration may allow commands to be simply checked-out and run, without the need for any development on the base framework or any application. For a project or a team which deploys new code frequently, this may save a significant amount of time and resources, and may limit the amount of human error introduced into systems.

In embodiments, troubleshooting commands, audit commands and other network element commands may be stored in a catalog and managed through a repository such as Git, which may allow version control. This catalog will be included in a CICD pipeline, for example Jenkins or SonarQube pipeline, and may be deployed as a service and exposed as an Application Programming Interface (API) to any service to be consumed.

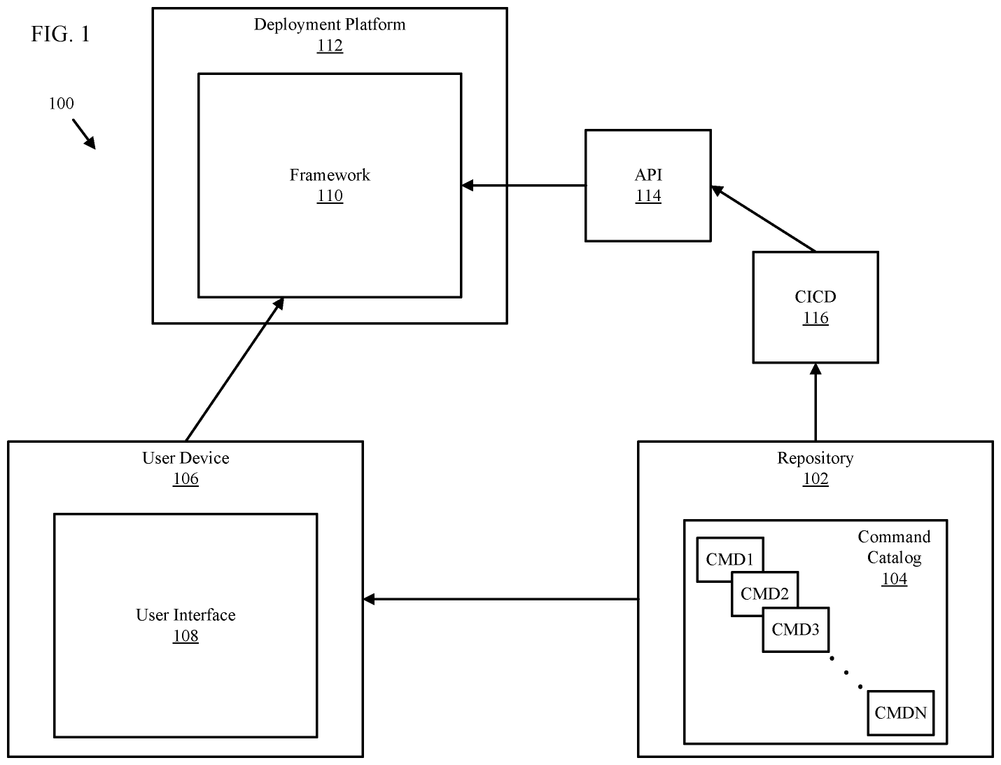

FIG. 1 is a diagram of an overview of an embodiment described herein. As shown in FIG. 1, a network management system 100 may include a repository 102, which may include a command catalog 104. In embodiments, repository 102 may be a Git repository, which may allow version control of commands stored in repository 102. Command catalog 104 may store one or more commands, for example command CMD1, command CMD2, command CMD3, and command CMDN. The one or more commands may be, for example, commands for controlling network elements.

In embodiments, the one or more commands may be commands for establishing or altering configurations of one or more network elements, for determining or monitoring a status of one or more network elements, for obtaining information about one or more network elements, or any other operation relating to network elements, as desired. In embodiments, the one or more commands may relate to troubleshooting, auditing, root-cause analysis (RCA) such as automatically-triggered RCA, notifications such as e-mail or short message service (SMS) notifications when thresholds are breached, and generation and monitoring of key performance indicator (KPI) data.

In embodiments, command catalog 104 may store information corresponding to the one or more commands. For example, command catalog 104 may store command payloads which may enable framework 110 to execute the one or more commands, and command metadata which may identify the one or more commands. In embodiments, command catalog 104 may store information indicating whether a particular command is executable on a particular network element.

In embodiments, command catalog 104 may also store information about how to process output data generated by the one or more network elements in response to the one or more commands. For example, this information may relate to regular expressions which may capture and format or otherwise process the output data. In embodiments, the regular expressions may relate to a Python regular expression library.

Network management system 100 may also include deployment platform 112, which may include framework 110. Framework 110 may operate on deployment platform 112. In embodiments, deployment platform 112 may operate on a server or a cloud server, and framework 110 may be a Python-based framework, or any other type of framework as desired. In embodiments, framework 110 may be a script deployed to deployment platform 112 by user device 106. Framework 110 may control one or more network elements. For example, framework 110 may retrieve one or more commands from repository 102, and may execute the one or more commands to control one or more network elements. In embodiments, the one or more commands may be provided to framework 110 using one or more of application programming interface 114 and CICD element 116. In embodiments, CICD element 116 may be a CICD pipeline such as Jenkins and SonarQube.

Network management system 100 may also include a user device 106, which may include a user interface 108. User interface 108 may be accessed by a user in order to operate network management system 100. For example, a user may access user interface 108 to control user device 106 to request information relating to one or more commands from command catalog 104, and may use the information to control framework 110 to execute the one or more commands. In embodiments, user device 106 may be a device for running or accessing an operation support system (OSS), and user interface 108 may be a user interface for controlling the OSS.

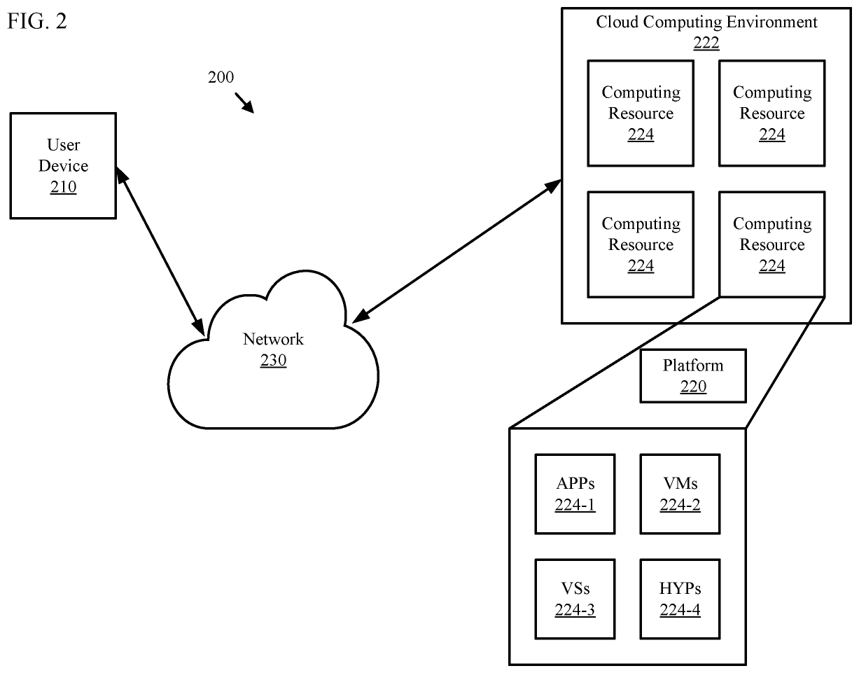

FIG. 2 is a diagram of an example environment 200 in which systems and/or methods, described herein, may be implemented. As shown in FIG. 2, environment 200 may include a user device 210, a platform 220, and a network 230. Devices of environment 200 may interconnect via wired connections, wireless connections, or a combination of wired and wireless connections. In embodiments, any of the functions of the elements included in network management system 100 may be performed by any combination of elements illustrated in FIG. 2. For example, in embodiments, user device 210 may perform one or more functions associated with user device 106, and platform 220 may perform one or more functions associated with any of deployment platform 112, repository 102, API 114, and CICD element 116.

User device 210 includes one or more devices capable of receiving, generating, storing, processing, and/or providing information associated with platform 220. For example, user device 210 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 210 may receive information from and/or transmit information to platform 220.

Platform 220 includes one or more devices capable of determining a heart rate of a subject using RPPG, as described elsewhere herein. In some implementations, platform 220 may include a cloud server or a group of cloud servers. In some implementations, platform 220 may be designed to be modular such that certain software components may be swapped in or out depending on a particular need. As such, platform 220 may be easily and/or quickly reconfigured for different uses.

In some implementations, as shown, platform 220 may be hosted in cloud computing environment 222. Notably, while implementations described herein describe platform 220 as being hosted in cloud computing environment 222, in some implementations, platform 220 is not be cloud-based (i.e., may be implemented outside of a cloud computing environment) or may be partially cloud-based.

Cloud computing environment 222 includes an environment that hosts platform 220. Cloud computing environment 222 may provide computation, software, data access, storage, etc. services that do not require end-user (e.g., user device 210) knowledge of a physical location and configuration of system(s) and/or device(s) that hosts platform 220. As shown, cloud computing environment 222 may include a group of computing resources 224 (referred to collectively as “computing resources 224” and individually as “computing resource 224”).

Computing resource 224 includes one or more personal computers, workstation computers, server devices, or other types of computation and/or communication devices. In some implementations, computing resource 224 may host platform 220. The cloud resources may include compute instances executing in computing resource 224, storage devices provided in computing resource 224, data transfer devices provided by computing resource 224, etc. In some implementations, computing resource 224 may communicate with other computing resources 224 via wired connections, wireless connections, or a combination of wired and wireless connections.

As further shown in FIG. 2, computing resource 224 includes a group of cloud resources, such as one or more applications (“APPs”) 224-1, one or more virtual machines (“VMs”) 224-2, virtualized storage (“VSs”) 224-3, one or more hypervisors (“HYPs”) 224-4, or the like.

Application 224-1 includes one or more software applications that may be provided to or accessed by user device 210. Application 224-1 may eliminate a need to install and execute the software applications on user device 210. For example, application 224-1 may include software associated with platform 220 and/or any other software capable of being provided via cloud computing environment 222. In some implementations, one application 224-1 may send/receive information to/from one or more other applications 224-1, via virtual machine 224-2.

Virtual machine 224-2 includes a software implementation of a machine (e.g., a computer) that executes programs like a physical machine. Virtual machine 224-2 may be either a system virtual machine or a process virtual machine, depending upon use and degree of correspondence to any real machine by virtual machine 224-2. A system virtual machine may provide a complete system platform that supports execution of a complete operating system (“OS”). A process virtual machine may execute a single program, and may support a single process. In some implementations, virtual machine 224-2 may execute on behalf of a user (e.g., user device 210), and may manage infrastructure of cloud computing environment 222, such as data management, synchronization, or long-duration data transfers.

Virtualized storage 224-3 includes one or more storage systems and/or one or more devices that use virtualization techniques within the storage systems or devices of computing resource 224. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 224-4 may provide hardware virtualization techniques that allow multiple operating systems (e.g., “guest operating systems”) to execute concurrently on a host computer, such as computing resource 224. Hypervisor 224-4 may present a virtual operating platform to the guest operating systems, and may manage the execution of the guest operating systems. Multiple instances of a variety of operating systems may share virtualized hardware resources. Network 230 includes one or more wired and/or wireless networks. For example, network 230 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

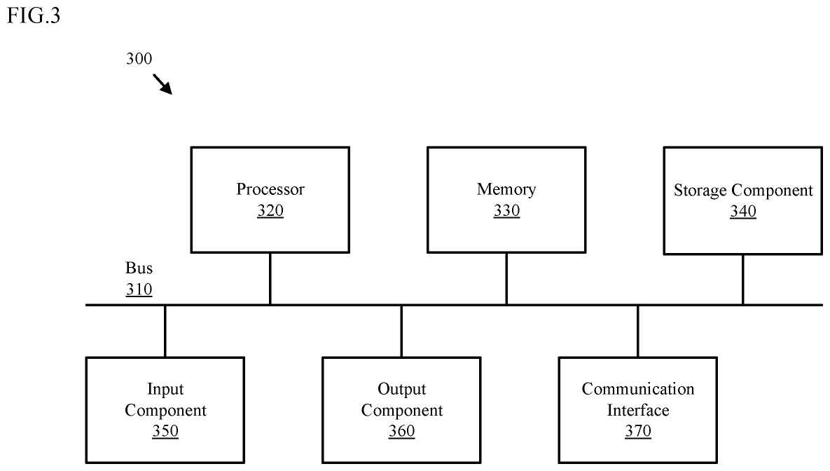

FIG. 3 is a diagram of example components of a device 300. Device 300 may correspond to user device 210 and/or platform 220. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 is implemented in hardware, firmware, or a combination of hardware and software. Processor 320 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

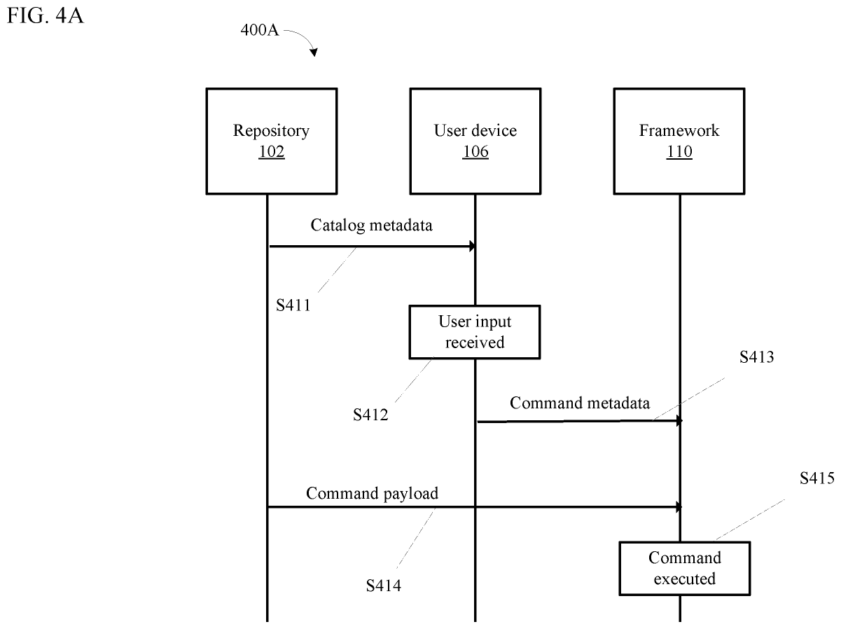

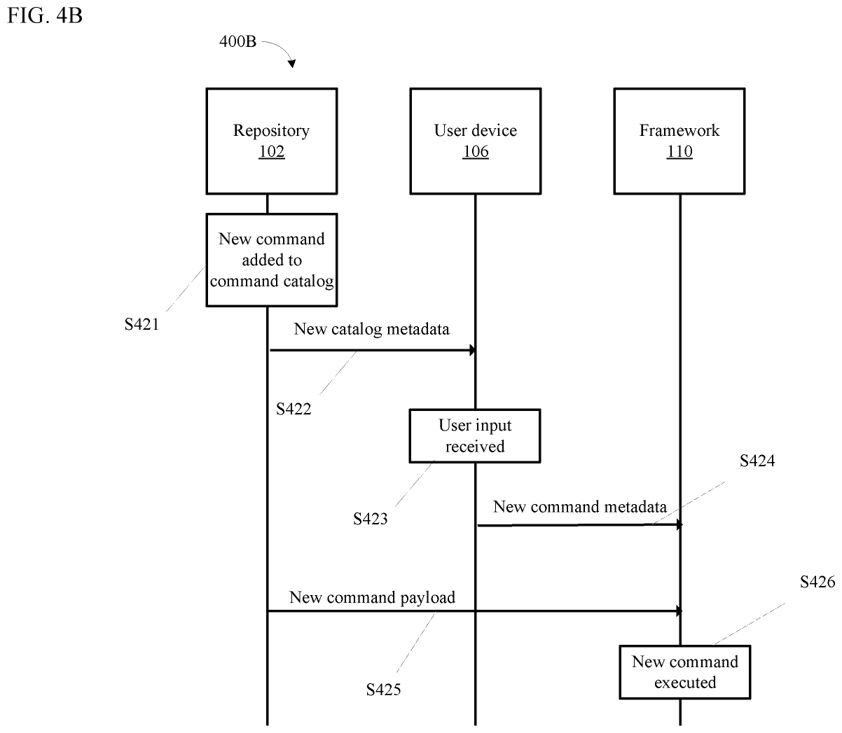

FIGS. 4A-4B are flow charts of example processes 400A-400B for managing at least one network element. As illustrated in FIGS. 4A-4B, one or more process blocks of processes 400A-400B may be performed by repository 102, user device 106, or framework 110 operating on deployment platform 112. In embodiments, one or more process blocks of processes 400A-400B may be performed by or using other elements illustrated in FIG. 1, for example user interface 108, command catalog 104, CICD 116, and API 114. In some implementations, one or more process blocks of FIGS. 4A-4B may be performed by platform 220. In some implementations, one or more process blocks of FIG. 4 may be performed by another device or a group of devices separate from or including platform 220, such as user device 210.

As shown in FIG. 4A, catalog metadata corresponding to command catalog 104 may be transmitted from repository 102 to user device 106 at operation S411. In embodiments, the catalog metadata may be automatically fetched by user device 106 based on a program being executed in user interface 108. In embodiments, the catalog metadata may be periodically transmitted, or may be transmitted based on an update being received to command catalog 104.

As further shown in FIG. 4A, a user input may be received at user interface 108 on user device 106 at operation S412. For example, the user input may include one or more of user inputs for selecting a network element type, selecting a network element, selecting a command corresponding to the selected network element, selecting or specifying a parameter corresponding to the command, and executing the command.

As further shown in FIG. 4A, command metadata corresponding to the user input may be transmitted from user device 106 to framework 110 at operation S413. The command metadata may be obtained by user device 106 from the catalog metadata. The command metadata may identify at least one of the selected network element, the selected command, and the specified parameter associated with the user input.

As further shown in FIG. 4A, a command payload may be transmitted from repository 102 to framework 110 based on the command metadata at operation S414. For example, the command payload may include information which enables framework 110 to execute the selected command. In embodiments, the command payload may include one or more regular expressions which may enable framework 110 to process output generated by the selected network element based on the selected command. In embodiments, the command payload may be obtained by framework 110 from API 114, which may obtain the command payload from the command catalog through CICD element 116.

As further shown in FIG. 4A, framework 110 may use the command payload to execute the selected command on the selected network element at operation S415. In embodiments, framework 110 may obtain output data generated by the network element based on the selected command, process the output data using the one or regular expressions, and provide the processed output data to the user device 106 to be displayed using user interface 108.

As shown in FIG. 4B, a new command can be added to command catalog 104 at operation S421. For example, the new command may include new command metadata and a new command payload. In embodiments, the new command may be an update to an existing command, or may be an entirely new command unrelated to an existing command. In embodiments, the new command may be added to command catalog 104 using a Git push.

As shown in FIG. 4B, new catalog metadata corresponding to command catalog 104 may be transmitted from repository 102 to user device 106 at operation S422. In embodiments, the new catalog metadata may include the new command metadata. In embodiments, the new catalog metadata may be automatically fetched by user device 106 based on a program being executed in user interface 108. In embodiments, the catalog metadata may be periodically transmitted, or may be transmitted based on the new command being added to command catalog 104.

As further shown in FIG. 4B, a user input may be received at user interface 108 on user device 106 at operation S423. For example, the user input may include one or more of user inputs for selecting a network element type, selecting a network element, selecting the new command, selecting or specifying a parameter corresponding to the new command, and executing the new command.

As further shown in FIG. 4B, the new command metadata corresponding to the user input may be transmitted from user device 106 to framework 110 at operation S424. The command metadata may be obtained by user device 106 from the new catalog metadata. The new command metadata may identify at least one of the selected network element, the selected new command, and the specified parameter associated with the user input.

As further shown in FIG. 4B, the new command payload may be transmitted from repository 102 to framework 110 based on the new command metadata at operation S425. For example, the new command payload may include information which enables framework 110 to execute the selected new command. In embodiments, the new command payload may include one or more regular expressions which may enable framework 110 to process output generated by the selected network element based on the selected new command. In embodiments, the new command payload may be obtained by framework 110 from API 114, which may obtain the new command payload from the command catalog through CICD element 116.

As further shown in FIG. 4B, framework may use the new command payload to execute the selected new command on the selected network element at operation S426. In embodiments, framework 110 may obtain output data generated by the network element based on the selected command, process the output data using the one or regular expressions, and provide the processed output data to the user device 106 to be displayed using user interface 108.

In this manner, command catalog 104 may be continually updated with new and updated commands, and these new and updated commands may be used by a user to control network elements without requiring an update or change to framework 110. Accordingly, a single framework 110 may be used in many different situations, to control many different network elements using many different commands.

Although FIGS. 4A-4B show example blocks of processes 400A and 400B, in some implementations, processes 400A and 400B may include additional blocks, fewer blocks, different blocks, or differently arranged blocks than those depicted in FIGS. 4A-4B. In embodiments, example blocks of process 400A may be combined in any order or amount with example blocks of process 400B. In embodiments, two or more of the blocks of processes 400A and 400B may be performed in parallel.

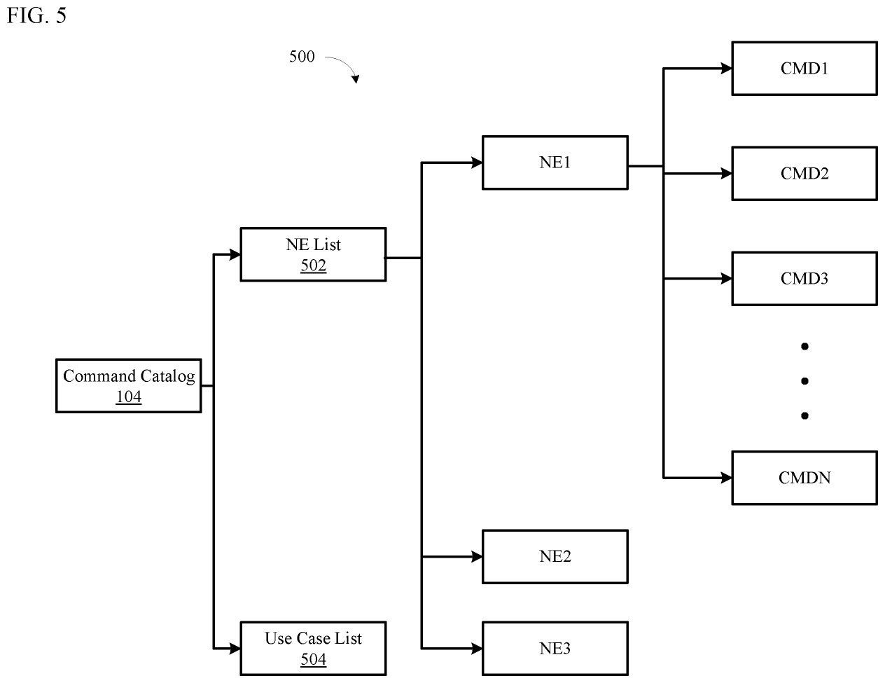

FIG. 5 is a diagram of an example of a command catalog, according to embodiments. As shown in FIG. 5, command catalog 104 may be organized according to a tree structure 500. For example, command catalog 104 may include network element list 502. Network element list 502 may be a list of a plurality of network elements, for example network element NE1, network element NE2, and network element NE3, although embodiments are not limited to these network elements.

For each network element, command catalog 104 may include a corresponding list of commands which may be executed on the network element. For example, as illustrated in FIG. 5, the commands CMD1 through CMDN may correspond to network element NE1. Although FIG. 5 only illustrates commands corresponding to network element NE1, in embodiments network element NE2, network element NE3, and any other network element included in command catalog 104 may include any number of commands, as desired. In embodiments, as discussed above, command catalog 104 may include command payloads and command metadata corresponding to the commands listed for each network element.

As further illustrated in FIG. 5, command catalog 104 may also include a use case list 504. Use case list 504 may include one or more use cases, which may be collections of network elements, corresponding commands, and other information such as parameters which relate to particular scenarios or events.

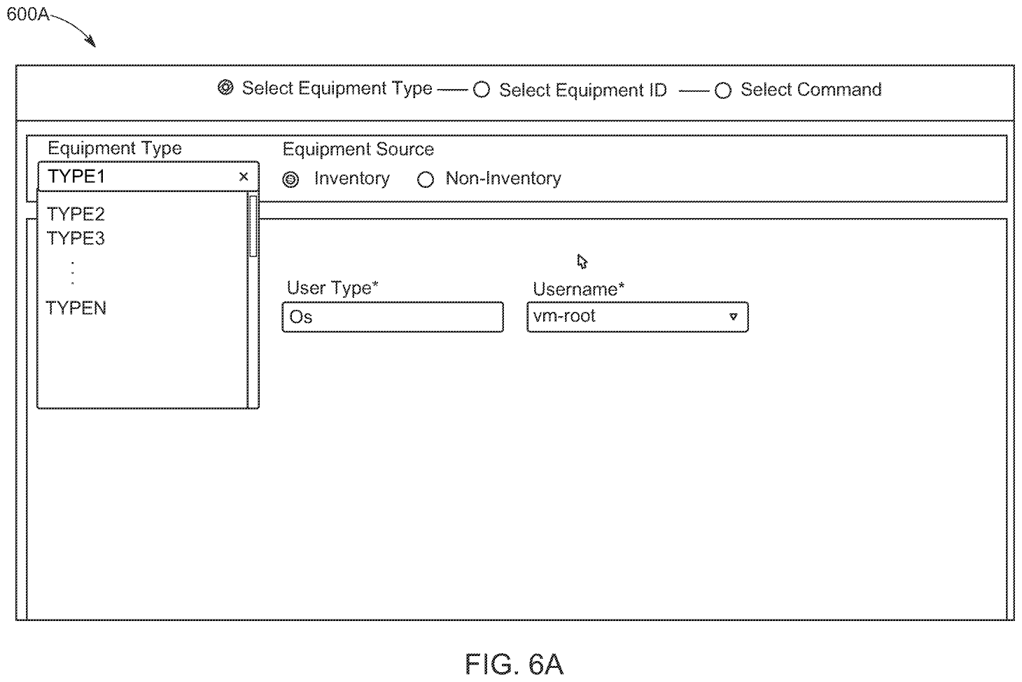

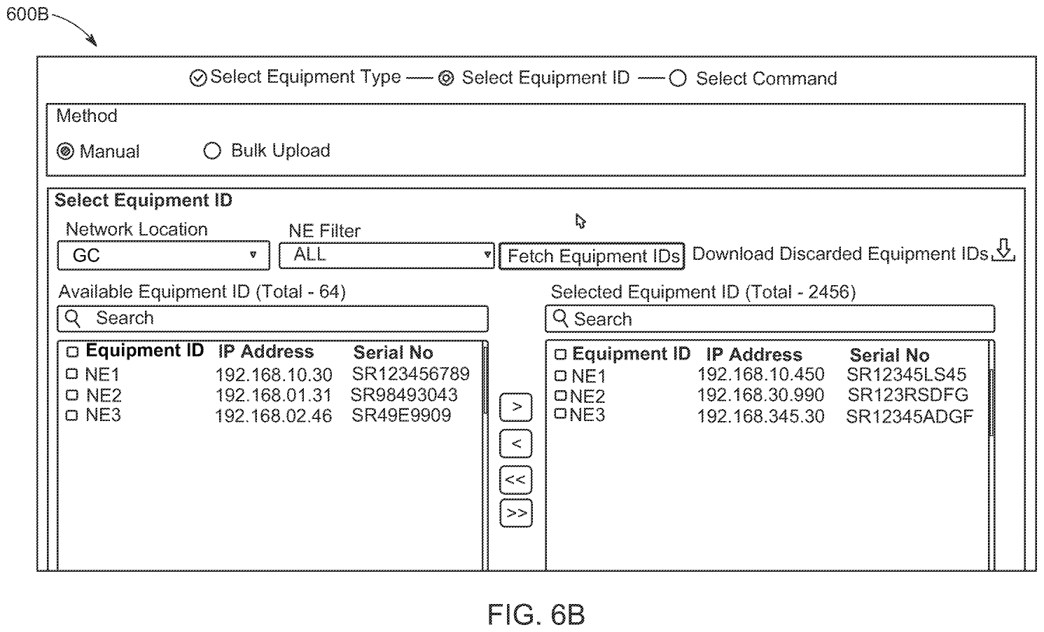

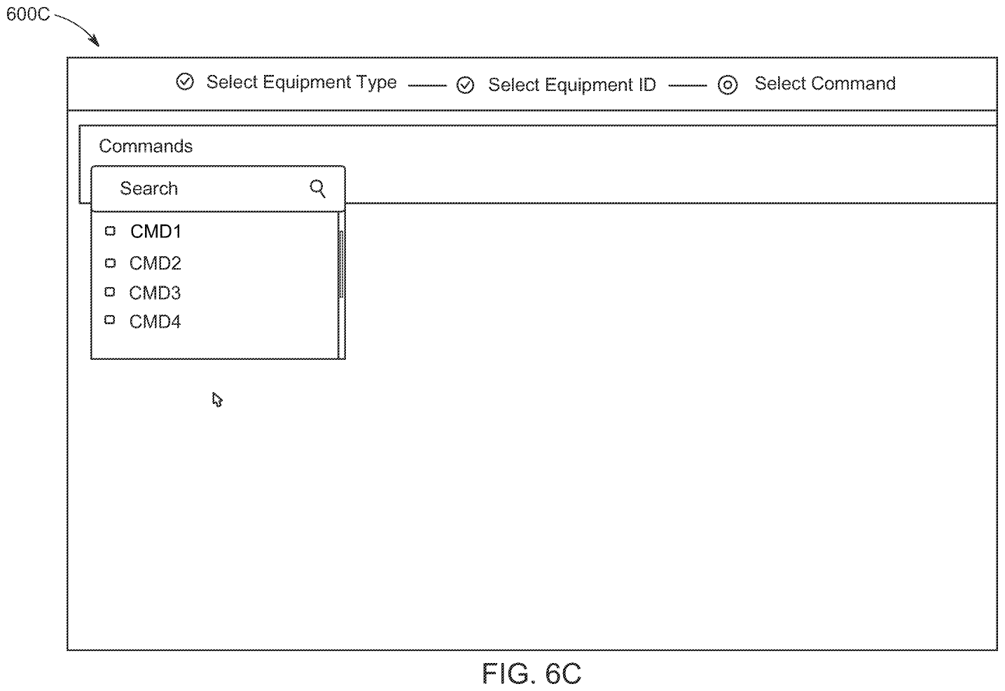

FIGS. 6A-6C are diagrams of an example user interface of a network management system, according to embodiments. In embodiments, the user interface screens shown in FIGS. 6A-6C may be associated with user interface 108 discussed above.

As shown in FIG. 6A, a first user interface screen 600A may display a list of network element types, for example TYPE1 through TYPEN, of network elements that the user wishes to control, and may allow a user to select one or more of the network element types.

As shown in FIG. 6B, after a user has selected a particular network element type, a second user interface screen 600B may display a list of network elements, for example network elements NE1 through NE3, that the user wishes to control. In embodiments, a user may select one or more of the displayed network elements, for example by selecting a check box associated with a network element. As shown in FIG. 6B, the network elements may be displayed on second user interface screen 600B along with identifying information such as equipment identifiers, Internet Protocol (IP) addresses or serial numbers. In addition, second user interface screen 600B may allow a user to apply filters to the displayed list of network elements, for example by selecting a particular network location, or by applying any other kind of filter.

As shown in FIG. 6C, after a user has selected one or more network elements, a third user interface screen 600C may display a list of commands, for example network elements CMD1 through CMDN, that the user wishes to execute on the selected one or more network elements. In embodiments, a user may select one or more of the displayed commands, for example by selecting a check box associated with a command. In embodiments, third user interface screen 600C may allow the user to select or modify parameters associated with the commands, or trigger execution of the commands, for example by framework 110.

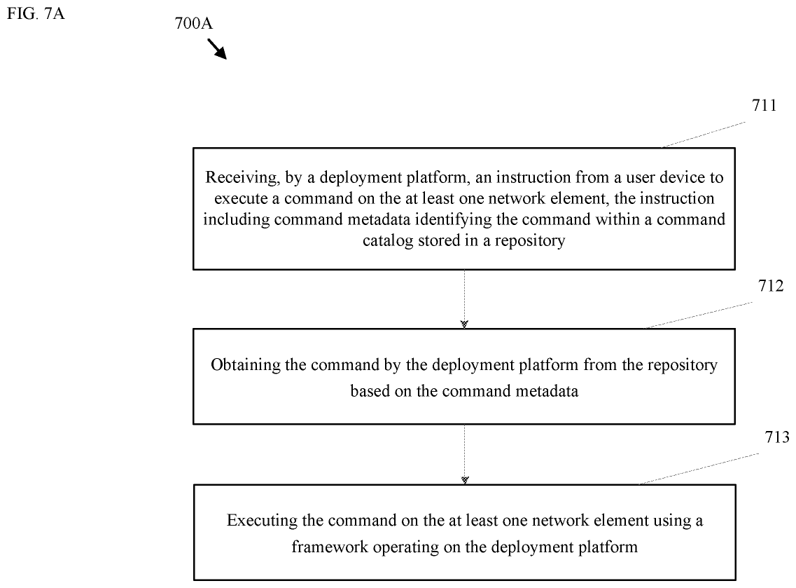

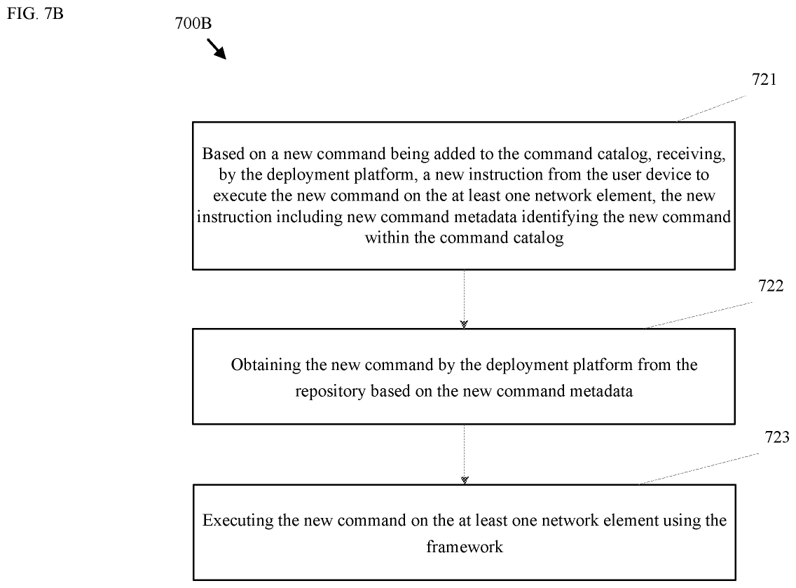

FIGS. 7A-7B are flow charts of example processes 700A-700B for managing at least one network element. As illustrated in FIGS. 4A-4B, one or more process blocks of processes 400A-400B may be performed by repository 102, user device 106, or framework 110 operating on deployment platform 112. In embodiments, one or more process blocks of processes 400A-400B may be performed by or using other elements illustrated in FIG. 1, for example user interface 108, command catalog 104, CICD 116, and API 114. In some implementations, one or more process blocks of FIGS. 7A-7B may be performed by platform 220. In some implementations, one or more process blocks of FIG. 4 may be performed by another device or a group of devices separate from or including platform 220, such as user device 210.

As shown in FIG. 7A, process 700A may include receiving, by a deployment platform, an instruction from a user device to execute a command on the at least one network element, the instruction comprising command metadata identifying the command within a command catalog stored in a repository (block 711). In embodiments, the deployment platform may correspond to deployment platform 112, the user device may correspond to user device 106, the command catalog may correspond to command catalog 104, and the repository may correspond to repository 102.

As further shown in FIG. 7A, process 700A may include obtaining the command by the deployment platform from the repository based on the command metadata (block 712).

As further shown in FIG. 7A, process 700A may include executing the command on the at least one network element using a framework operating on the deployment platform (block 713). In embodiments, the framework may correspond to framework 110.

As shown in FIG. 7B, process 700B may include, based on a new command being added to the command catalog, receiving, by the deployment platform, a new instruction from the user device to execute the new command on the at least one network element, the new instruction comprising new command metadata identifying the new command within the command catalog (block 721).

As further shown in FIG. 7B, process 700B may include obtaining the new command by the deployment platform from the repository based on the new command metadata (block 722).

As further shown in FIG. 7B, process 700B may include executing the new command on the at least one network element using the framework (block 723). In embodiments, the framework may correspond to framework 110.

In embodiments, the framework may be capable of executing all commands included in the command catalog.

In embodiments, the framework may include a script deployed to the deployment platform by the user device.

In embodiments, the executing of the command may include configuring the at least one network element according to the command.

In embodiments, the command may be obtained by the deployment platform through an application program interface associated with the repository.

In embodiments, the command catalog may include information indicating whether the command is executable on the at least one network element.

Although FIGS. 7A-7B show example blocks of processes 700A and 700B, in some implementations, processes 700A and 700B may include additional blocks, fewer blocks, different blocks, or differently arranged blocks than those depicted in FIGS. 7A-7B. In embodiments, example blocks of process 700A may be combined in any order or amount with example blocks of process 700B. In embodiments, two or more of the blocks of processes 700A and 700B may be performed in parallel.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

1. A method of managing at least one network element, the method comprising:
receiving, by a deployment platform, an instruction from a user device to execute a command on the at least one network element, the instruction comprising command metadata identifying the command within a command catalog stored in a repository, wherein the command metadata is selected by the user device from among catalog metadata obtained by the user device from the repository;
obtaining the command by the deployment platform from the repository based on the command metadata; and
executing the command on the at least one network element using a framework operating on the deployment platform,
wherein the command metadata explicitly specifies the command.

2. The method of claim 1, further comprising:
based on a new command being added to the command catalog, receiving, by the deployment platform, a new instruction from the user device to execute the new command on the at least one network element, the new instruction comprising new command metadata identifying the new command within the command catalog;
obtaining the new command by the deployment platform from the repository based on the new command metadata; and
executing the new command on the at least one network element using the framework.

3. The method of claim 1, wherein the framework is capable of executing all commands included in the command catalog.

4. The method of claim 3, wherein the framework comprises a script deployed to the deployment platform by the user device.

5. The method of claim 1, wherein the executing of the command comprises configuring the at least one network element according to the command.

6. The method of claim 1, wherein the command is obtained by the deployment platform through an application program interface associated with the repository.

7. The method of claim 1, wherein the command catalog includes information indicating whether the command is executable on the at least one network element.

8. A deployment platform for managing at least one network element, the deployment platform comprising:
a memory configured to store instructions; and
one or more processors configured to execute the instructions to:
receive an instruction from a user device to execute a command on the at least one network element, the instruction comprising command metadata identifying the command within a command catalog stored in a repository, wherein the command metadata is selected by the user device from among catalog metadata obtained by the user device from the repository;
obtain the command from the repository based on the command metadata; and
execute the command on the at least one network element using a framework operating on the deployment platform,
wherein the command metadata explicitly specifies the command.

9. The deployment platform of claim 8, wherein the one or more processors is further configured to execute the instructions to:
based on a new command being added to the command catalog, receive a new instruction from the user device to execute the new command on the at least one network element, the new instruction comprising new command metadata identifying the new command within the command catalog;
obtain the new command by the deployment platform from the repository based on the new command metadata; and
execute the new command on the at least one network element using the framework.

10. The deployment platform of claim 8, wherein the framework is capable of executing all commands included in the command catalog.

11. The deployment platform of claim 10, wherein the framework comprises a script deployed to the deployment platform by the user device.

12. The deployment platform of claim 8, wherein the executing of the command comprises configuring the at least one network element according to the command.

13. The deployment platform of claim 8, wherein the command is obtained by the deployment platform through an application program interface associated with the repository.

14. The deployment platform of claim 8, wherein the command catalog includes information indicating whether the command is executable on the at least one network element.

15. A non-transitory computer-readable medium storing instructions, the instructions comprising: one or more instructions that, when executed by one or more processors of a deployment platform for managing at least one network element, cause the one or more processors to:
receive an instruction from a user device to execute a command on the at least one network element, the instruction comprising command metadata identifying the command within a command catalog stored in a repository, wherein the command metadata is selected by the user device from among catalog metadata obtained by the user device from the repository;
obtain the command from the repository based on the command metadata; and
execute the command on the at least one network element using a framework operating on the deployment platform,
wherein the command metadata explicitly specifies the command.

16. The non-transitory computer-readable medium of claim 15, wherein the one or more instructions further cause the one or more processors to:
based on a new command being added to the command catalog, receive a new instruction from the user device to execute the new command on the at least one network element, the new instruction comprising new command metadata identifying the new command within the command catalog;
obtain the new command by the deployment platform from the repository based on the new command metadata; and
execute the new command on the at least one network element using the framework.

17. The non-transitory computer-readable medium of claim 15, wherein the framework is capable of executing all commands included in the command catalog.

18. The non-transitory computer-readable medium of claim 15, wherein the executing of the command comprises configuring the at least one network element according to the command.

19. The non-transitory computer-readable medium of claim 15, wherein the command is obtained by the deployment platform through an application program interface associated with the repository.

20. The non-transitory computer-readable medium of claim 15, wherein the command catalog includes information indicating whether the command is executable on the at least one network element.
